(19) United States
(12) Patent Application Publication
(10) Pub. No.: US 2024/0346576 A1
(43) Pub. Date: Oct. 17, 2024

(54) MULTI-MODAL TRANSACTION CLASSIFICATION FRAMEWORK

(71) Applicant: PAYPAL, INC., San Jose, CA (US)

(72) Inventors: Jiadi Xiong, San Jose, CA (US); Chaoyun Chen, Sunnyvale, CA (US); Yaqin Yang, Santa Clara, CA (US); Hang Li, Los Altos, CA (US); Ximin Chen, San Jose, CA (US)

(21) Appl. No.: 18/301,574

(22) Filed: Apr. 17, 2023

(51) Int. Cl. G06Q 40/00

(52) U.S. Cl. CPC G06Q 40/00

(57) ABSTRACT

Methods and systems are presented for providing a multi-modal machine learning model framework for using enriched data to improve the accuracy of a machine learning model in classifying transactions. Upon receiving a request to process a transaction associated with a purchase of an item, a classification system extracts text data associated with the transaction from the request. Based on the text data, the classification system retrieves additional data related to the item. The additional data is of different modality than the text data. The classification system may transform the text data and the additional data into respective vectors, and merge the vectors for use as input data for the machine learning model. Based on the merged vectors, the classification system obtains multiple classification scores from the machine learning model. The classification system then classifies the transaction based on the multiple classification scores, and processes the transaction according to the classification.

### BACKGROUND

The present specification generally relates to machine learning models, and more specifically, to providing a machine learning model framework for classifying transactions according to various embodiments of the disclosure.

### RELATED ART

Machine learning models have been widely used to perform various tasks for different reasons. For example, machine learning models may be used in classifying transactions (e.g., determining whether a transaction is a legitimate transaction or a fraudulent transaction, determining whether a transaction complies with a set of policies or not, etc.). To construct a machine learning model, a set of input features that are related to performing a task associated with the machine learning model are identified. Training data that is associated with the type of task to be performed by the machine learning model (e.g., historic transactions) can be used to train the machine learning model such that the machine learning model can learn various patterns associated with the training data and perform classification predictions based on the learned patterns.

While a machine learning model can be effective in learning patterns, the accuracy of its prediction is highly dependent on the types and the quality of input data provided to the model for generating an output. When the quality of the input data is low, or when the types of input data available to the model are limited, the prediction accuracy of the model may suffer. As such, there is a need for providing a framework for using enriched data to improve the prediction accuracy of machine learning models in classifying transactions.

### BRIEF DESCRIPTION OF THE FIGURES

FIG. 1 is a block diagram illustrating an electronic transaction system according to an embodiment of the present disclosure;

FIG. 2 illustrates a transaction processing module configured to perform transaction classification according to an embodiment of the present disclosure;

FIG. 3 illustrates an example flow for preparing input data for a classification model configured to classify transactions according to an embodiment of the present disclosure;

FIG. 4 is a flowchart showing a process of classifying transactions according to an embodiment of the present disclosure;

FIG. 5 illustrates an example neural network that can be used to implement a machine learning model according to an embodiment of the present disclosure; and

FIG. 6 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a multi-modal machine learning model framework that generates enriched data in different modalities and embeds the enriched data into input data for a machine learning model to improve the accuracy of the machine learning model in performing a task. In some embodiments, the task may be associated with classifying an item (e.g., a product, a service, etc.) associated with a transaction (e.g., a purchase transaction, an exchange transaction, a chargeback transaction, etc.). For example, when a payment service provider receives a payment transaction request for purchasing an item, the payment service provider may need to classify the item associated with the payment transaction (e.g., whether the item complies with a use policy, whether the item is an illegal item for sale in a jurisdiction in which the payment transaction takes place, whether the item corresponds to a counterfeit good, etc.). The payment transaction request typically includes text data associated with the item (e.g., a brief description of the item either provided by the seller or the buyer). As such, the payment service provider may classify the item based on the text data included in the payment transaction request. For example, the payment service provider may classify the item as compliant or non-compliant to its use policies, etc. Based on the classification of the item, the payment service provider may process the payment transaction request accordingly. For example, the payment service provider may authorize the payment transaction request when the item is classified as a legitimate item (e.g., the item is compliant with the use policy, the item is a legal item for sale in the jurisdiction, the item does not correspond to a counterfeit good, etc.), but may deny the payment transaction request when the item is classified as an illegitimate item (e.g., the item does not comply with the use policy, the item is an illegal item for sale in the jurisdiction, the item corresponds to a counterfeit good, etc.).

In another example, when the payment service provider receives a chargeback request from a user (e.g., the user requesting for a refund based on a previously conducted transaction, etc.), the user may provide text data (e.g., a brief description related to a reason for the refund, such as, the item received is the wrong item, the item has a defect, etc.). In some embodiments, the payment service provider may determine that the chargeback request is a fraudulent request if the text data related to the reason for the refund is inconsistent with the previously conducted transaction. Thus, the payment service provider may classify the item based on the text data, and may determine whether the classification of the item based on the text data in the chargeback request is consistent with a classification of the item determined while processing the previously conducted transaction. The payment service provider may then authorize the chargeback request if the classification determined based on the text data in the chargeback request is consistent with the classification of the item determined while processing the previously conducted transaction, and may deny the chargeback request if the classification determined based on the text data in the chargeback request is inconsistent with the classification of the item determined while processing the previously conducted transaction.

In some embodiments, the payment service provider may use a keyword-based approach in classifying the item. Under the keyword-based approach, the payment service provider may scan the text data for the presence of any predetermined keywords. For example, if the use policy of the payment service provider prohibits the sale of tobacco-related products, the payment service provider may determine whether the text data associated with the item includes any one of the words: “tobacco,” “cigar,” “cigarette,” “vape,” or other tobacco-related words, and may classify the item based on whether the text data includes any one of the predetermined keywords. However, under such a strict keyword-based approach, many products that are not tobacco-related may be inaccurately classified as non-compliant due to the inclusion of one or more of those keywords in the product descriptions (e.g., “tobacco room spray,” “tobacco colored leather boots,” etc.), and products that are tobacco-related may be inaccurately classified as compliant due to the exclusion of certain keywords in the text data (e.g., mis-spelled words, the merchant or the user providing incomplete or inaccurate description, etc.), resulting in unacceptably low accuracy performance (e.g., having a high false positive rate, a high false negative rate, or both).

In another example, if it is illegal to purchase/sell weapons in a particular jurisdiction, the payment service provider may determine the text data associated with the item includes the words “gun,” “bomb,” “blast,” “ammo,” or other weapon-related words, and may classify the item based on whether the text data includes any of the predetermined keywords. Thus, an item having a description of “smokeless gun powder” will be classified as non-compliant due to the inclusion of the word “gun.” Similarly, a product having a description of “Topps Series 1 Blaster Box” may also be classified as non-compliant under the keyword-based approach, based on the inclusion of the word “blaster,” even though the product is related to a box of baseball cards instead of weaponry.

In some embodiments, instead of using such a strict keyword-based approach, the payment service provider may use a machine learning model (e.g., a natural language processing (NLP) model) to classify the item based on text data. For example, the payment service provider may configure a machine learning model to classify items based on the text data. By training the machine learning model using text data from previously correctly classified training data (e.g., previously correctly classified payment transactions, previously correctly classified chargeback requests, etc.), the machine learning model may produce a classification output based on any text data from a request (e.g., a transaction request, a chargeback request, etc.). Instead of scanning for keywords in the text data, the machine learning model may take into account all of the words (not just the keywords) included in the text data and the relationships (e.g., relative positions) among the words. The machine learning model may then learn patterns based on the words and their relationships among each other, and use the learned pattern to generate an output indicating a classification of the item. Since the machine learning model analyzes all of the words in the text data and their relationship among each other, the classifications provided by the machine learning model may be more accurate than the classifications produced under the keyword-based approach. For example, an item having a description of “tobacco room spray” may be correctly classified as compliant using the machine learning model (e.g., an NLP model), since the model would be able to understand that the item is a room spray based on the other words included in the text data, and that the word “tobacco” is used to describe a scent of the product instead of the item itself.

However, the classification accuracy of the machine learning model may still be unacceptable (e.g., having a false positive rate being above a threshold, etc.), due to the limitation of the input data (e.g., the text data being just a short description of the item, etc.). For example, the machine learning model may still classify the item “Topps Series 1 Blaster Box” as non-compliant since the remaining words in the text data (e.g., other than the word “blaster”) do not provide any additional information indicating what the item is. As discussed herein, the limiting amount and/or quality of the input data may likely reduce the accuracy of the classification prediction of the machine learning model, as there is simply insufficient data for the machine learning model to effectively learn the patterns of the input data.

As such, according to various embodiments of the disclosure, a classification system may use a multi-modal machine learning model framework for performing the classification task. Under the multi-modal machine learning model framework, the classification system may determine (e.g., generate or otherwise obtain) additional data based on the text data included in the classification request, where the additional data may enrich the text data and enable a machine learning model to perform the classification task more accurately (e.g., to an accuracy performance above a predetermined threshold, etc.). In some embodiments, the additional data may be of a different modality than the text data. For example, the additional data may include multimedia data, such as one or more of image data, video data, audio data, etc., that is of a different modality from the text data. In one example, the classification system may use an application programming interface (API) of a third-party server (e.g., a server associated with a search engine, etc.) to retrieve the additional data from the third-party server (e.g., by transmitting a data request based on the text data using the API, etc.). In another example, the classification system may crawl the web, and may select data (e.g., images, videos, audio clips, etc.) that matches the text data.

Since the performance of the machine learning model can be limited by the types and the quality of input data provided to the machine learning model, as described herein, by enriching the input data (e.g., the text data) with the additional data that is in a different modality than the text data and/or that is of better quality, the accuracy performance of the machine learning model in performing the task may be improved. In some embodiments, the additional data may include images of the item (images that were retrieved by a search engine based on using the text data as the search query). The images of the item may provide additional information that supplement the text data to provide a better indication of what the item is (e.g., whether the item is compliant or non-compliant with the policies, etc.). For the item having the text description of “tobacco room spray,” the images retrieved by the classification system may likely include bottles/cans of air freshener sprays. Thus, while the NPL model may be able to determine, strictly based on the text data, that the item is likely a room spray instead of a tobacco product, the images of the item may provide an additional confirmation that the item is indeed compliant with the policies. For the item having the text description of “Topps Series 1 Blaster Box,” the NLP model may determine that the item is related to weaponry based on the text data alone, as discussed above. If the text data is the only source of input, the classification system may classify the item as non-compliant (e.g., weapons related, etc.). However, images that are retrieved based on the text data may reveal that the item is a box of baseball cards, which is unrelated to weaponry. Thus, by combining the images (retrieved based on the text data) with the text data, the classification system may be enabled to perform the task with a higher accuracy.

In some embodiments, the additional data retrieved by the classification system may include multiple portions (e.g., different files in a set of files). For example, when the additional data includes image data, the additional data may include multiple images (e.g., 10, 20, 50, etc.). When the additional data includes audio data, the additional data may include multiple audio clips. Since the additional data is retrieved based on the text data, the classification system may determine that at least a majority of the additional data is related to the item (e.g., images of the item, etc.). However, it is possible that, due to the limits of the text data (e.g., which may be brief and sometimes inaccurate/incomplete), some of the additional data may not be related to the item. As such, in some embodiments, after retrieving the additional data (e.g., multiple image files, multiple audio clips, etc.), the classification system may filter out portions of the additional data that are not related to the item.

In some embodiments, the classification system may provide each portion (e.g., each image, each audio clip, etc.) of the additional data to a preliminary model (which may also be a machine learning model) configured to classify the type of data included in the additional data. For example, if the additional data includes images, the preliminary model may be configured to classify images into different categories (e.g., product categories, classification categories, etc.). The classification system may obtain outputs, from the preliminary model, corresponding to the different portions (e.g., different images), and may determine a statistical value based on the outputs (e.g., an average, a mean, a mode, etc.). The classification may then determine if any portion in the additional data has a deviation from the statistical value that exceeds a threshold (indicating that the portion is an outlier form the remaining portions of the additional data), and may remove that portion from the additional data. The removal of portion(s) of the additional data that is unrelated to the item may further improve the accuracy improvement of the classification system.

In some embodiments, after obtaining (and filtering) the additional data, the classification system may merge the additional data with the text data, such that the merged data can be provided to the machine learning model collectively as input data. For example, the classification system may convert the text data into a vector (e.g., a text vector) using a language transformer. The text vector may include a set of values (e.g., numerical values, etc.) representing the text in the text data. The text vector may represent the characters in the text data, the words that appear in the text data, and the relationships among the words (e.g., the relative positions of the words) in the text data.

The classification system may also convert each portion of the additional data (e.g., each image, each audio clip, etc.) into a secondary vector (e.g., an image vector, an audio vector, etc.). When an image is converted into an image vector using a vision transformer, the image vector may include a set of values (e.g., numerical values, etc.) that represent different attributes of the image. In some embodiments, the image vector may represent colors within the image, outlines or characteristics of any shapes/objects detected within the image, a size of the image, and other attributes of the image.

In some embodiments, the classification system may merge the text vector with each one of the secondary vectors (vectors that are generated based on the additional data, such as the image vectors, the audio vectors, etc.) to generate a set of combined vectors. Each combined vector may be generated based on the text vector and one of the secondary vectors. For example, the classification system may generate a combined vector by concatenating a secondary vector (e.g., an image vector, an audio vector, etc.) to the text vector. Thus, each combined vector may include numerical values associated with both the text data and the corresponding portion of the additional data.

If the additional data includes data of different modalities (e.g., including both image data and audio data, etc.), the classification system may also convert each portion of the additional data into corresponding secondary vectors. In such a scenario, the classification system may generate each combined vector by merging the text vector with a secondary vector corresponding to a first modality (e.g., corresponding to an image), and a secondary vector corresponding to a second modality (e.g., corresponding to an audio clip).

In some embodiments, in addition to retrieving the additional data based on the text data, the classification system may also retrieve more additional data related to a user interface of a merchant through which the transaction is conducted. For example, the classification system may crawl through the user interface (e.g., a merchant website of the merchant), and determine additional data from the website, such as structural data (e.g., a layout of the website, a hierarchy of webpages in the website, an organization of the source code associated with the website, etc.), location data associated with the website (e.g., which server and the location of the server that hosts the website), and content associated with the website (e.g., other products offered for sale in the website, etc.). The additional data derived from the merchant user interface may also be transformed into a secondary vector to be merged with the other vectors to generate the combined vectors.

In some embodiments, the classification system may configure the machine learning model to accept the combined vector (e.g., the values in the combined vector) as input values for classifying the item. As such, the machine learning model may be configured to analyze the combined vector, and produce an output (e.g., a classification score, etc.) that indicates a classification for a corresponding item. In some embodiments, the classification system may generate training data (e.g., previously correctly classified item having a corresponding text description and additional data retrieved based on the text description) and train the machine learning model based on the training data. The additional data usable for the training data may be retrieved and filtered using the same techniques as described herein.

In some embodiments, the classification system may determine one or more hyperparameters for use during the training of the machine learning model. The one or more hyperparameters may specify, to the machine learning model, different weights assigned to different portions of the combined vector. For example, the one or more hyperparameters may indicate a first weight assigned to a first portion of the combined vector (e.g., the text vector portion) corresponding to the text data and a second weight assigned to a second portion of the combined vector (e.g., the image vector portion) corresponding to the image. If the additional data includes data of multiple modalities and/or sources, the one or more hyperparameters may also indicate weights for the other portions corresponding to the other modalities of additional data (e.g., a third weight assigned to a third portion corresponding to an audio clip, a fourth weight assigned to a fourth portion corresponding to user interface data, etc.).

Based on the one or more hyperparameters, the machine learning model may analyze the different portions of the combined vector according to the different assigned weights to produce the output. Since the additional data (e.g., images, audio files, user interface data, etc.) may include unrelated information (e.g., objects that appear in the background of an image, objects that are not the item but are associated with the item, such as an accessory to the item, that appear on the image, etc.), the one or more hyperparameters may also specify which sections of the additional data (e.g., which areas within an image, etc.) should be given larger weights than other sections. Through the training process, the weights given to different portions of the combined vector may be further fine-tuned to optimize the accuracy performance of the machine learning model.

As discussed herein, the classification system may generate different combined vectors for the same item (e.g., by merging the text vector with different secondary vectors, etc.). As such, the classification system may obtain multiple outputs (e.g., multiple classification scores) from the machine learning model. In some embodiments, the classification system may generate a combined output by performing a mathematical operation (e.g., a sum, an average, a mean, etc.) on the multiple outputs, and may determine a classification of the item based on the combined output. By enriching the text data based on the additional data using the techniques disclosed herein, the classification system may enable the machine learning model to improve its accuracy performance (e.g., that meets a predetermined accuracy threshold).

In some embodiments, for each incoming transaction, the classification system may initially use a machine learning model (e.g., the NLP model) to produce a classification output for the item associated with the transaction, based only on the text data of the transaction. If the classification output obtained from the NLP model indicates a confidence level above a threshold, the classification system may use the classification output from the NLP model to classify the item and/or the transaction. However, if the classification output obtained from the NLP model indicates a confidence level below the threshold, the classification system may use the techniques herein to enrich the text data with additional data, and classify the item and/or the transaction based on the combination of the text data and the additional data. By selectively performing the data enrichment only for certain transactions that do not provide sufficiently clear descriptions, the speed performance and use of computing resources for classifying transactions can be improved without sacrificing accuracy.

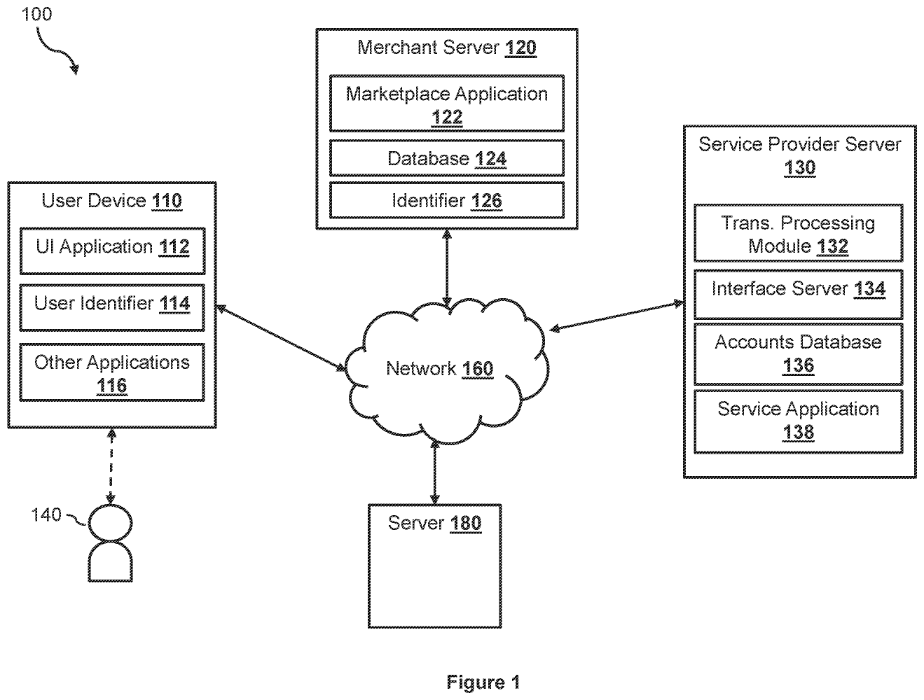

FIG. 1 illustrates an electronic transaction system 100, within which the classification system may be implemented according to one embodiment of the disclosure. The electronic transaction system 100 includes a service provider server 130, a merchant server 120, a user device 110, and a server 180 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to conduct a purchase transaction with the merchant server 120 and/or the service provider server 130, to initiate a chargeback transaction request, etc.).

The merchant server 120, in various embodiments, may be maintained by a business entity (or in some cases, by a partner of a business entity that processes transactions on behalf of business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user device 110 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items and/or transactions are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The server 180 may be associated with a content provider (e.g., an online search engine, a cloud data storage, etc.) that is configured to provide data (e.g., the additional data) to the user 140 and/or the service provider server 130 based on a content request. In some embodiments, the content request may be in the form of a query. As such, the user 140 and/or the service provider server 130 may submit a content request (e.g., a query such as a search query, etc.) and may obtain data (e.g., text data, image data, audio data, etc.) from the server 180 based on the content request. While only one server is shown, there may be several different servers, each associated with a different content provider, such that content and data may be obtained from a variety of sources.

The service provider server 130, in one embodiment, may be maintained by a transaction processing entity or an online service provider, which may provide processing of electronic transactions between the users of the user device 110 and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140 or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an accounts database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a transaction processing module 132 that implements the classification system as discussed herein. The transaction processing module 132 may be configured to process transaction requests received from the user device 110 and/or the merchant server 120 via the interface server 134. In some embodiments, the transaction processing module 132 may be configured to classify the item involved in each transaction request, and may process the transaction request based on the classification of the item. For example, a payment service provider associated with the service provider server 130 may have a set of policies governing the types of items that users of the service provider server 130 can transact. The set of policies may be jurisdictional such that a different set of prohibited items may be designated for a different jurisdiction (e.g., prohibiting sales of drugs in one country, and prohibiting sales of weaponry in another country, etc.). As such, the transaction processing module 132 may classify the item in each transaction request as compliant (e.g., in compliance with the policies of the payment service provider) or non-compliant (e.g., not in compliance with the policies of the payment service provider). The transaction processing module 132 may then authorize the transaction request when the item is classified as compliant and may deny the transaction request when the item is classified as non-compliant.

In another example, the service provider server 130 may receive a chargeback request from a user (e.g., the user 140, etc.) based on a previously conducted purchase transaction. When the previously conducted purchase transaction was processed, the item associated with the previously conducted purchase transaction may have been classified (e.g., by the transaction processing module 132, by another module of the service provider server 130, or classified manually by an agent of the payment service provider) into a first classification indicating a type of product associated with the item. The chargeback request may also include text data provided by the user (e.g., a brief description related to a reason for the refund, such as, the item received is the wrong item, the item has a defect, etc.). In some embodiments, the transaction processing module 132 may determine a second classification of the item associated with the chargeback request based on the text data included in the chargeback request. The second classification may also indicate a type of product associated with the item. In some embodiments, the transaction processing module 132 may compare the two classifications and may determine that the chargeback request is associated with a fraudulent request when the two classifications do not match. As such, the transaction processing module 132 may authorize the chargeback request when the two classifications match, and may deny the chargeback request when the two classifications do not match.

In some embodiments, the transaction processing module 132 may classify items associated with the various transaction requests (e.g., purchase transaction requests, chargeback requests, etc.) using the multi-modal machine learning model framework as discussed herein. As such, after receiving a transaction request that includes text data (e.g., description of an item involved in a purchase transaction, a reason for a dispute/refund request, etc.), the transaction processing module 132 may generate or otherwise obtain additional data based on the text data. In some embodiments, the transaction processing module 132 may generate a query (e.g., a search query) based on the text data included in the transaction request, and may submit the query to the server 180 (e.g., using an application programming interface (API) of the server 180). After obtaining the additional data based on the text data (e.g., from the server 180), the transaction processing module 132 may merge the additional data with the text data, and may classify the item involved in the transaction request based on the merged data.

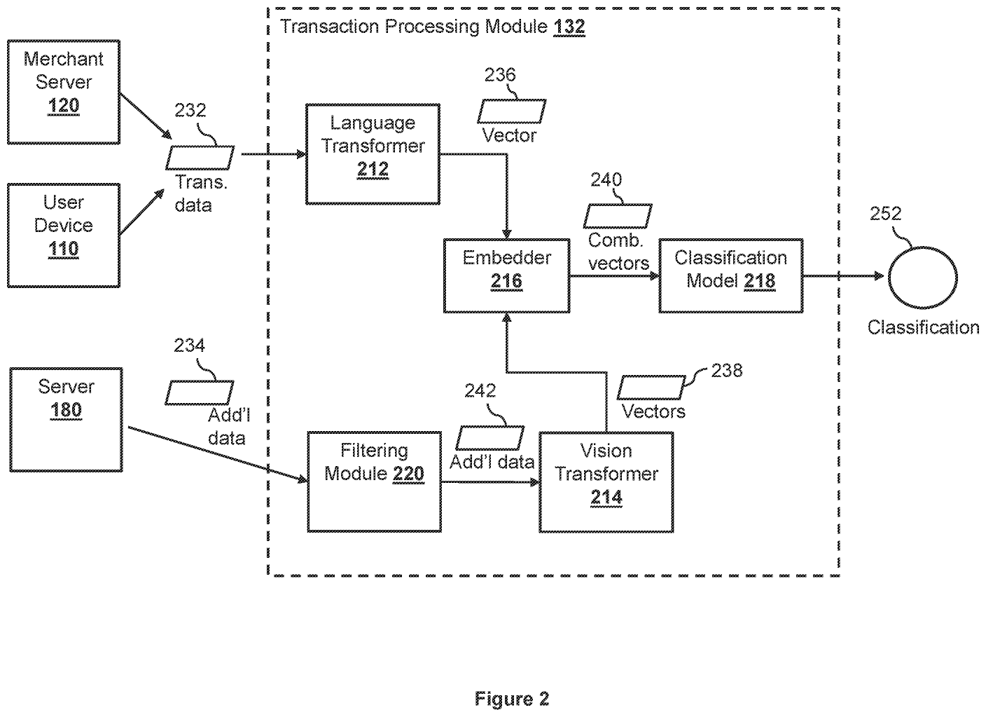

FIG. 2 illustrates the transaction processing module 132 according to various embodiments of the disclosure. As shown, the transaction processing module 132 includes a language transformer 212, a vision transformer 214, an embedder 216, a classification model 218, and a filtering module 220. In some embodiments, as the transaction processing module 132 receives a transaction request from the merchant server 120 and/or the user device 110, the transaction processing module 132 may extract transaction data 232 from the transaction request. As discussed herein, the transaction data 232 may include text data, such as a description of a product involved in the transaction request. In some embodiments, the transaction processing module 132 may generate a query based on the transaction data 232, and may transmit the query to a content provider, such as the server 180 over the network 160.

Based on the query submitted to the server 180, the transaction processing module 132 may receive additional data 234. In some embodiments, the additional data 234 may include data in a different modality than the transaction data 232. For example, where the transaction data 232 includes text data, the additional data may include at least one of image data, video data, audio data, metadata associated with a user interface, etc. In some embodiments, the transaction processing module 132 may determine the amount of additional data (e.g., the number of images, the number of audio clips, etc.) to be retrieved based on various attributes of the transaction request. For example, the transaction processing module 132 may determine to retrieve a larger amount of additional data (e.g., a larger number of images, a larger number of audio clips, etc.) when the transaction amount is higher, and may determine to retrieve a smaller amount of additional data (e.g., a smaller number of images, a smaller number of audio clips, etc.) when the transaction amount is lower. Other types of attributes of the transaction request may affect the amount of additional data to be retrieved, and the transaction processing module 132 may dynamically adjust the amount of transaction data based on the transaction request.

Since the additional data is retrieved based on the text data, it can be assumed that at least a majority of the additional data is related to the item (e.g., images of the item, etc.). However, it has been contemplated that, due to the limits of the transaction data 232 (e.g., which may be brief and sometimes inaccurate description of the item), some of the additional data retrieved from the server 180 may not be related to the item. As such, in some embodiments, after retrieving the additional data (e.g., multiple image files, multiple audio clips, etc.), the transaction processing module 132 may use the filtering module 220 to filter out portions of the additional data that are not related to the item.

In some embodiments, the filtering module 220 may include a model (e.g., a machine learning model) that is configured to classify the additional data (e.g., classifying images, classifying audio clips, etc.) into different categories (e.g., product categories, compliance categories, etc.). If all of the additional data (e.g., all of the images, all of the audio clips, etc.) is related to the same time, they should all correspond to the same classification category. Any outlier within the additional data may be deemed to be unrelated to the item, and should be removed from the additional data.

Thus, the filtering module 220 may provide each portion of the additional data 234 (e.g., each image, each audio clip, etc.) to the model, and obtain a classification output from the model. In some embodiments, the filtering module 220 may determine a statistical value (e.g., an average, a mean, a mode, etc.) based on all classification outputs obtained from the model corresponding to the additional data 234. For any portion of the additional data 234 that has a classification output that deviates from the statistical value, the filtering module 220 may determine that the portion is an outlier, and may remove that portion from the additional data 234. The transaction processing module 132 may obtain the filtered additional data 242 from the filtering module 220.

In some embodiments, the transaction processing module 132 may merge the additional data 242 with the transaction data 232, such that the merged data can be provided to the classification model 218 collectively as input data. To merge the additional data 242 with the transaction data 232, the transaction processing module 132 may first transform the transaction data 232 and the different portions of the additional data into respective vectors. For example, the transaction processing module 132 may use the language transformer 212 to transform the transaction data 232 into a text vector 236. The text vector 236 may include a set of values (e.g., numerical values, etc.) representing the text in the transaction data 232. The text vector 236 may represent the characters in the text data, the words that appear in the transaction data 232, and the relationships among the words (e.g., the relative positions of the words) in the transaction data 232.

The transaction processing module 132 may also convert each portion of the additional data 242 (e.g., each image, each audio clip, user interface data, etc.) into a secondary vector 238 (e.g., an image vector, an audio vector, etc.). For example, when the additional data 242 includes image data, the transaction processing module 132 may use a vision transformer 214 to transform the additional data 242 into image vectors. When an image is converted into an image vector using the vision transformer 214, the image vector may include a set of values (e.g., numerical values, etc.) that represent different attributes of the image. In some embodiments, the image vector may represent colors within the image, outlines or characteristics of any shapes/objects detected within the image, a size of the image, and other attributes of the image.

On the other hand, if the additional vector 238 includes audio data, the transaction processing module 132 may use another transformer (e.g., an audio transformer) to transform the additional data into audio vectors. When an audio clip is converted into an audio vector using the transformer, the audio vector may include a set of values (e.g., numerical values, etc.) that represent different attributes of the audio clip. In some embodiments, the audio vector may represent frequency data, recognized words/sound from the audio clip, and other attributes of the audio clip.

In some embodiments, after generating the text vector 236 and the secondary vectors 238, the transaction processing module 132 may use the embedder 216 to merge the text vector 236 with each one of the secondary vectors 238 to generate a set of combined vectors 240. Each combined vector in the set of combined vectors 240 may be generated based on the text vector 236 and one of the secondary vectors 238. For example, the transaction processing module 132 may generate a combined vector by concatenating a secondary vector (e.g., an image vector, an audio vector, etc.) to the text vector 236. Thus, each combined vector in the set of combined vectors 240 may include numerical values associated with both the text data and the corresponding portion of the additional data.

When the additional data includes different modalities (e.g., the additional data includes two or more of images, audio clips, and user interface metadata, etc.), the embedder 216 may combine the text vector 236 with multiple secondary vectors, each corresponding to a different modality. For example, if the additional data includes images of the item and metadata of a merchant website associated with a merchant, the embedder 216 may concatenate the text vector 236 with a secondary vector corresponding to a first modality (e.g., an image) and a secondary vector corresponding to a second modality (e.g., user interface metadata, etc.).

In some embodiments, the transaction processing module 132 may configure the classification model 218 (which may be a machine learning model, such as an artificial neural network, etc.) to accept any combined vector (e.g., the values in the combined vector) as input values for classifying the item corresponding to the transaction request. As such, the classification model may be configured to analyze each one of the combined vectors 240, and produce an output 252 (e.g., a classification score, etc.) that indicate a classification for a corresponding item (e.g., the item involved in the transaction request).

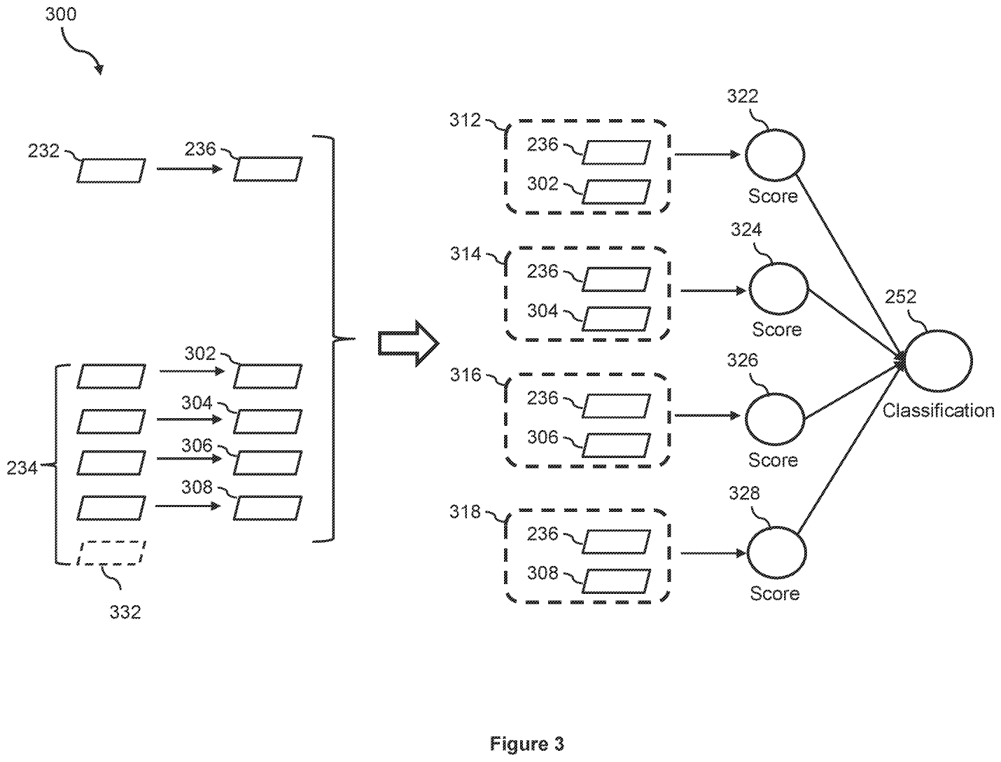

FIG. 3 illustrates an example flow 300 of preparing input data for a machine learning model configured to classify transactions according to various embodiments of the disclosure. As discussed herein, the transaction processing module 132 may obtain the transaction data 232 from the merchant server 120 and/or the user device 110, and the additional data 234 from the server 180 based on the transaction data 232. The transaction data 232 may include text data in some embodiments. As such, the transaction processing module 132 may use the language transformer 212 to transform the transaction data 232 into a vector 236 (also referred to as a “text vector 236”).

The additional data 234 may include data of a different modality than the transaction data. For example, the additional data 234 may include image data, video data, and/or audio data. Furthermore, as discussed herein, the additional data 234 may include multiple portions (e.g., multiple images, multiple audio clips, etc.). For example, the transaction processing module 132 may obtain multiple images from the server 180 based on the transaction data. In some embodiments, the transaction processing module 132 may use the filtering module 220 to filter out portion(s) of the additional data 234 (e.g., an image 332) that is determined to be unrelated to the item involved in the transaction. The transaction processing module 132 may then use another transformer to transform the remaining portions of the additional data 234 into secondary vectors. In an example where the remaining portions of the additional data 234 include four images, the transaction processing module 132 may use the vision transformer 214 to transform the four images to the respective secondary vectors 302, 304, 306, and 308.

After generating the text vector 236 and the secondary vectors 302, 304, 306, and 308, the transaction processing module 132 may use the embedder 216 to merge the vectors to generate a set of combined vectors, including combined vectors 312, 314, 316, and 318. For example, the embedder may generate the combined vector 312 by merging the text vector 236 and the secondary vector 302 (corresponding to a first portion of the additional data 234). The embedder may generate the combined vector 314 by merging the text vector 236 and the secondary vector 304 (corresponding to a second portion of the additional data 234). The embedder may generate the combined vector 316 by merging the text vector 236 and the secondary vector 306 (corresponding to a third portion of the additional data 234). The embedder may also generate the combined vector 318 by merging the text vector 236 and the secondary vector 308 (corresponding to a fourth portion of the additional data 234).

Different embodiments may use different techniques to merge the vectors for generating the combined vectors. In some embodiments, the embedder 216 may concatenate the two vectors (e.g., the text vector 236 and one of the secondary vectors). For example, to generate the combined vector 312, the embedder 216 may append the secondary vector 302 to the end of the text vector 236, such that the combined vector 312 includes values from both the text vector 236 and the secondary vector 302. In some embodiments, the embedder 216 may perform a mathematical operation (e.g., a sum, a multiplication, etc.) between each pair of values from the text vector 236 and the secondary vector 302.

As such, each of the combined vectors 312, 314, 316, and 318, represent a combination of the transaction data and a portion of the additional data (e.g., an image, an audio clip, etc.). The transaction processing module 132 may then provide the combined vectors 312, 314, 316, and 318, one at a time, to the classification model 218 for classifying the item of the transaction based on the respective combined vectors 312, 314, 316, and 318. For example, the transaction processing module 132 may provide the combined vector 312 to the classification model 218, and may obtain a classification output (e.g., a classification score 322) from the classification model 218. The transaction processing module 132 may provide the combined vector 314 to the classification model 218, and may obtain a classification output (e.g., a classification score 324) form the classification model 218. The transaction processing module 132 may provide the combined vector 316 to the classification model 218, and may obtain a classification output (e.g., a classification score 326) form the classification model 218. The transaction processing module 132 may also provide the combined vector 318 to the classification model 218, and may obtain a classification output (e.g., a classification score 328) from the classification model 218.

In some embodiments, the classification model 218 may be configured and trained to analyze any given combined vector and produce a classification output (e.g., a classification score) based on the given combined vector. In this regard, the transaction processing module 132 may configure the classification model 218 to accept data corresponding to the values in a combined vector as input data. The transaction processing module 132 may also generate training data based on previously classified items. For example, the transaction processing module 132 may obtain transaction data associated with previously classified transactions from the accounts database 136. If no additional data has been stored in association with the transactions, the transaction processing module 132 may use the same techniques described herein to obtain the additional data (e.g., from the server 180). In some embodiments, the transaction processing module 132 may also use the filtering module 220 to filter out (e.g., remove) portion(s) of the additional data that is unrelated to the transaction.

The transaction processing module 132 may also use the language transformer 212 and the vision transformer (or another transformer) to transform the transaction data and portions of the additional data, respectively, to corresponding vectors. The transaction processing module 132 may also use the embedder 216 to embed different combinations of the text vector and the secondary vectors to generate multiple combined vectors. Each of the combined vectors may be labeled with the classification that has been previously determined for the transaction. Each of the labeled combined vectors may be used as a distinct training data set for training the classification model 218. In some embodiments, the classification model 218 may be trained based on an objective (e.g., an objective function) to minimize the difference between an output and the label of the corresponding training data set.

In some embodiments, the transaction processing module 132 may also determine one or more hyperparameters for use during the training of the classification model 218. The one or more hyperparameters may specify, to the classification model 218, different weights assigned to different portions of a combined vector used as input data for the classification model 218. For example, the one or more hyperparameters may indicate a first weight assigned to a first portion of the combined vector (e.g., the text vector portion) corresponding to the text data and a second weight assigned to a second portion of the combined vector (e.g., the image vector portion) corresponding to the image.

Based on the one or more hyperparameters, the classification model 218 may analyze the different portions of the combined vector according to the different assigned weights to produce the classification output. Since the additional data (e.g., images, audio clips, etc.) may include unrelated information (e.g., objects that appear in the background of an image, objects that are not the item but are associated with the item, such as an accessory to the item, that appear on the image, etc.), the one or more hyperparameters may also specify which sections of the additional data (e.g., which areas within an image, etc.) should be given larger weights than other sections. Through the training process of the classification model 218, the weights given to different portions of the combined vector may be further fine-tuned to optimize the accuracy performance of the classification model 218.

Referring back to FIG. 3, once the transaction processing module 132 has obtained the various classification scores 322, 324, 326, and 328 corresponding to the different combined vectors 312, 314, 316, and 318, from the classification model 218, the transaction processing module 132 may determine a classification for the item involved in the transaction based on the scores 322, 324, 326, and 328. For example, the transaction processing module 132 may generate a composite classification score 252 based on the various classification scores 322, 324, 326, and 328 (e.g., a sum, an average, a mean, etc.) and may determine a classification based on the composite classification score 252 (e.g., determining that the item is non-compliant if the composite classification score 252 is above a threshold, and determining that the item is compliant if the composite classification score 252 is below the threshold, etc.). The transaction processing module 132 may then process the transaction based on the classification.

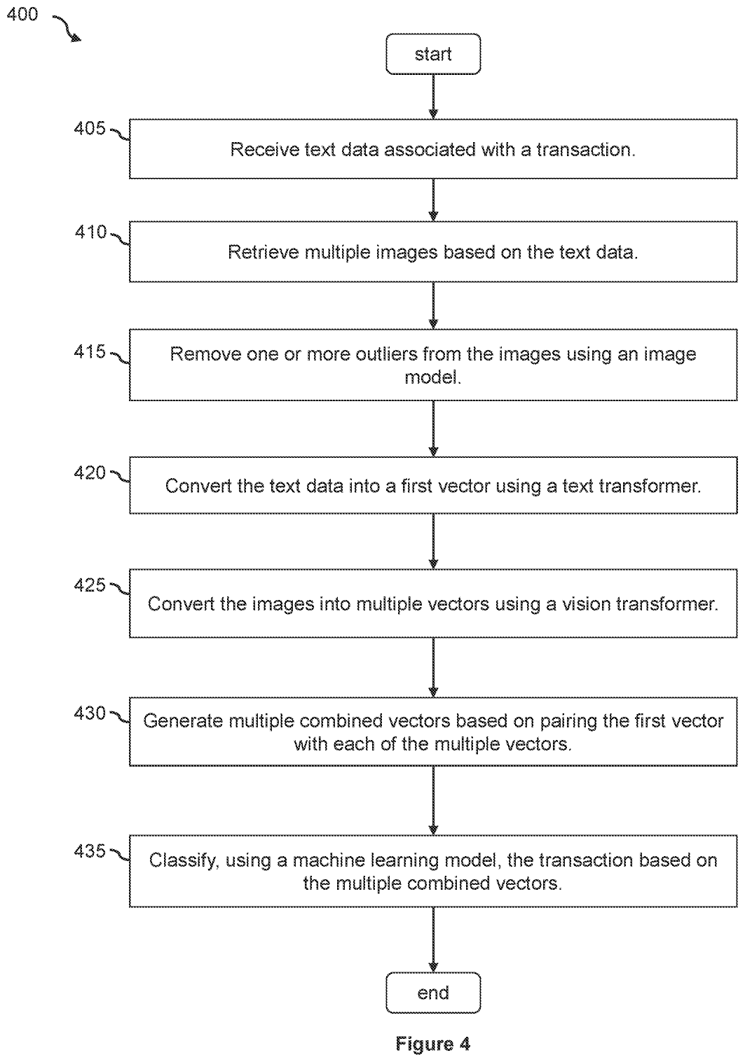

FIG. 4 illustrates a process 400 for using the multi-modal machine learning model framework to classify a transaction according to various embodiments of the disclosure. In some embodiments, at least a portion of the process 400 may be performed by the transaction processing module 132. The process 400 begins by receiving (at step 405) text data associated with a transaction. For example, the transaction processing module 132 may receive transaction data 232 associated with a transaction from the merchant server 120 and/or the user device 110. The transaction may be associated with a purchase transaction, a chargeback transaction, or other types of transaction that involve an item (e.g., a product such as a good or a service, etc.). In some embodiments, the transaction data 232 may include text data related to the item (e.g., a description of the item, etc.).

The process 400 then retrieves (at step 410) multiple images based on the text data, and removes (at step 415) one or more outliers from the images using an image model. For example, the transaction processing module 132 may generate a query based on the text data, and submit the query to an external server (e.g., the server 180). Based on the query submission, the transaction processing module 132 may obtain additional data (e.g., a set of images) from the server 180. In some embodiments, to improve the accuracy performance of the classification process, the transaction processing module 132 may remove one or more outliers from the additional data. For example, the transaction processing module 132 may provide each image to a preliminary classification model (e.g., a machine learning model) to obtain a classification (e.g., a score). The transaction processing module 132 may then compute an average or a mean based on the scores corresponding to the different images in the additional data. If any image(s) having a score that deviates from the average or the mean by more than a threshold, the transaction processing module 132 may remove that image(s) from the additional data, as the image(s) is likely unrelated to the item associated with in the transaction.

The process 400 converts (at step 420) the text data into a first vector using a text transformer, and converts (at step 425) the images into multiple vectors using a vision transformer. For example, after obtaining the transaction data 232 and the additional data 242, the transaction processing module 132 may use the language transformer 212 to transform the transaction data 232 to a text vector 236, and may use the vision transformer 214 to transform the additional data 242 to secondary vectors 238.

The process 400 then generates (at step 430) multiple combined vectors based on pairing the first vector with each of the multiple vectors, and classifies (at step 435), using a machine learning model, the transaction based on the multiple combined vectors. For example, the transaction processing module 132 may generate the combined vectors 240, that may include combined vectors 312, 314, 316, and 318 based on combining the text vector 236 to each of the secondary vectors 302, 304, 306, and 308. The transaction processing module 132 may then provide each of the combined vectors 312, 314, 316, and 318 to the classification model 218 to obtain respective classification scores 322, 324, 326, and 328. In some embodiments, the transaction processing module 132 may generate a composite classification score 252 based on the classification scores 322, 324, 326, and 328 (e.g., by taking a sum, an average, a mean, etc.), and may determine a classification for the transaction based on the composite classification score 252.

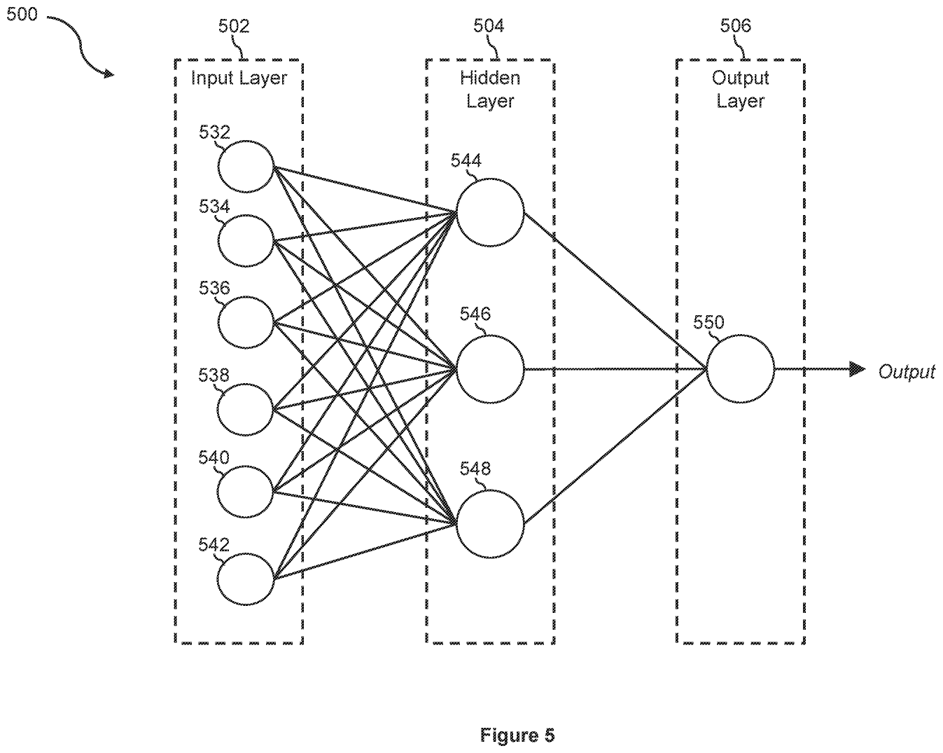

FIG. 5 illustrates an example artificial neural network 500 that may be used to implement a machine learning model, such as the classification model 218 and the model used by the filtering model 220 to filter portions of the additional data, etc. As shown, the artificial neural network 500 includes three layers—an input layer 502, a hidden layer 504, and an output layer 506. Each of the layers 502, 504, and 506 may include one or more nodes. For example, the input layer 502 includes nodes 532, 534, 536, 538, 540, and 542, the hidden layer 504 includes nodes 544, 546, and 548, and the output layer 506 includes a node 550. In this example, each node in a layer is connected to every node in an adjacent layer. For example, the node 532 in the input layer 502 is connected to all of the nodes 544, 546, and 548 in the hidden layer 504. Similarly, the node 544 in the hidden layer is connected to all of the nodes 532, 534, 536, 538, 540, and 542 in the input layer 502 and the node 550 in the output layer 506. Although only one hidden layer is shown for the artificial neural network 500, it has been contemplated that the artificial neural network 500 used to implement any one of the computer-based models may include as many hidden layers as necessary.

In this example, the artificial neural network 500 receives a set of inputs and produces an output. Each node in the input layer 502 may correspond to a distinct input. For example, when the artificial neural network 500 is used to implement the classification model 218, each node in the input layer 502 may correspond to a value in a combined vector (e.g., the combined vectors 312, 314, 316, and 318, etc.). On the other hand, when the artificial neural network 500 is used to implement the model used by the filtering module 220 to classify images, each node in the input layer 502 may correspond to a distinct image attribute (e.g., values of a distinct pixel, etc.).

In some embodiments, each of the nodes 544, 546, and 548 in the hidden layer 504 generates a representation, which may include a mathematical computation (or algorithm) that produces a value based on the input values received from the nodes 532, 534, 536, 538, 540, and 542. The mathematical computation may include assigning different weights (e.g., node weights, etc.) to each of the data values received from the nodes 532, 534, 536, 538, 540, and 542. The nodes 544, 546, and 548 may include different algorithms and/or different weights assigned to the data variables from the nodes 532, 534, 536, 538, 540, and 542 such that each of the nodes 544, 546, and 548 may produce a different value based on the same input values received from the nodes 532, 534, 536, 538, 540, and 542. In some embodiments, the weights that are initially assigned to the input values for each of the nodes 544, 546, and 548 may be randomly generated (e.g., using a computer randomizer). The values generated by the nodes 544, 546, and 548 may be used by the node 550 in the output layer 506 to produce an output value for the artificial neural network 500.

The artificial neural network 500 may be trained by using training data based on one or more loss functions and one or more hyperparameters. By providing training data to the artificial neural network 500, the nodes 544, 546, and 548 in the hidden layer 504 may be trained (adjusted) to achieve an objective according to the one or more loss functions and based on the one or more hyperparameters such that an optimal output is produced in the output layer 506 to minimize the loss in the loss functions. By continuously providing different sets of training data, and penalizing the artificial neural network 500 when the output of the artificial neural network 500 is incorrect (as defined by the loss functions, etc.), the artificial neural network 500 (and specifically, the representations of the nodes in the hidden layer 504) may be trained (adjusted) to improve its performance in the respective tasks. Adjusting the artificial neural network 500 may include adjusting the weights associated with each node in the hidden layer 504.

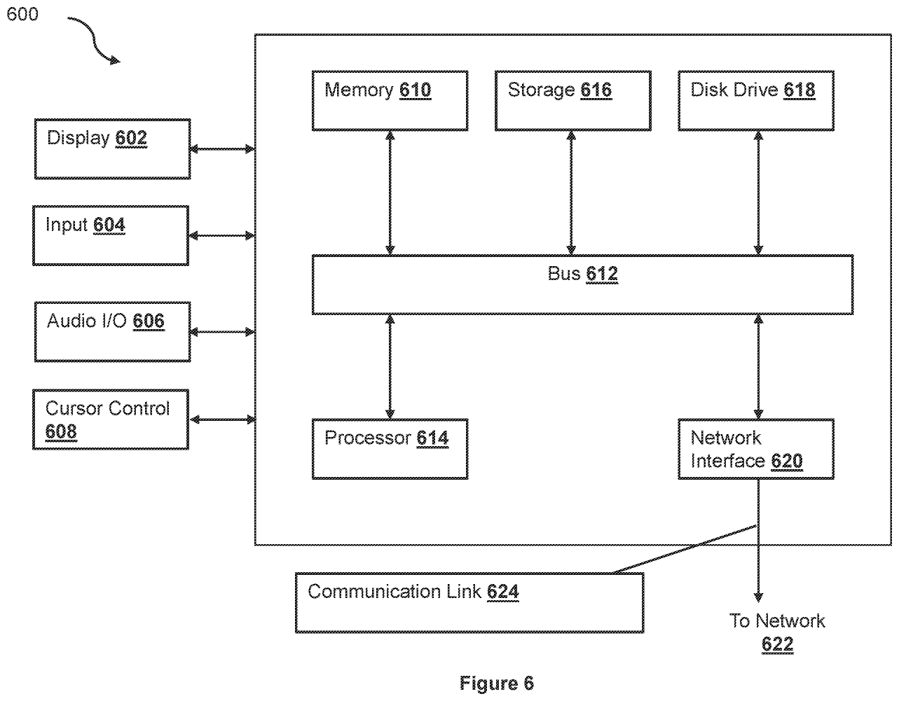

FIG. 6 is a block diagram of a computer system 600 suitable for implementing one or more embodiments of the present disclosure, including the service provider server 130, the merchant server 120, the server 180, and the user device 110. In various implementations, each of the user device 110 may include a mobile cellular phone, personal computer (PC), laptop, wearable computing device, etc. adapted for wireless communication, and each of the service provider server 130, the server 180, and the merchant server 120 may include a network computing device, such as a server. Thus, it should be appreciated that the devices 110, 120, 130, and 180 may be implemented as the computer system 600 in a manner as follows.

The computer system 600 includes a bus 612 or other communication mechanism for communicating information data, signals, and information between various components of the computer system 600. The components include an input/output (I/O) component 604 that processes a user (i.e., sender, recipient, service provider) action, such as selecting keys from a keypad/keyboard, selecting one or more buttons or links, etc., and sends a corresponding signal to the bus 612. The I/O component 604 may also include an output component, such as a display 602 and a cursor control 608 (such as a keyboard, keypad, mouse, etc.). The display 602 may be configured to present a login page for logging into a user account or a checkout page for purchasing an item from a merchant. An optional audio input/output component 606 may also be included to allow a user to use voice for inputting information by converting audio signals. The audio I/O component 606 may allow the user to hear audio. A transceiver or network interface 620 transmits and receives signals between the computer system 600 and other devices, such as another user device, a merchant server, or a service provider server via a network 622. In one embodiment, the transmission is wireless, although other transmission mediums and methods may also be suitable. A processor 614, which can be a micro-controller, digital signal processor (DSP), or other processing component, processes these various signals, such as for display on the computer system 600 or transmission to other devices via a communication link 624. The processor 614 may also control transmission of information, such as cookies or IP addresses, to other devices.

The components of the computer system 600 also include a system memory component 610 (e.g., RAM), a static storage component 616 (e.g., ROM), and/or a disk drive 618 (e.g., a solid-state drive, a hard drive). The computer system 600 performs specific operations by the processor 614 and other components by executing one or more sequences of instructions contained in the system memory component 610. For example, the processor 614 can perform the classification functionalities described herein, for example, according to the process 400.

Logic may be encoded in a computer readable medium, which may refer to any medium that participates in providing instructions to the processor 614 for execution. Such a medium may take many forms, including but not limited to, non-volatile media, volatile media, and transmission media. In various implementations, non-volatile media includes optical or magnetic disks, volatile media includes dynamic memory, such as the system memory component 610, and transmission media includes coaxial cables, copper wire, and fiber optics, including wires that comprise the bus 612. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 600. In various other embodiments of the present disclosure, a plurality of computer systems 600 coupled by the communication link 624 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
receiving text data associated with a transaction;
retrieving a plurality of images associated with the transaction based on the text data;
converting, using a text transformer, the text data into a first vector;
converting, using an image transformer, the plurality of images into a plurality of secondary vectors;
generating a plurality of combined vectors based on pairing the first vector with each of the plurality of secondary vectors;
classifying the transaction using a machine learning model based on the plurality of combined vectors; and
processing the transaction based on the classifying of the transaction.

2. The system of claim 1, wherein the operations further comprise:
providing each one of the plurality of combined vectors to the machine learning model; and
obtaining a plurality of outputs from the machine learning model based on the plurality of combined vectors, wherein the classifying is further based on the plurality of outputs.

3. The system of claim 2, wherein the operations further comprise:
calculating a composite output based on the plurality of outputs, wherein the classifying is further based on the composite output.

4. The system of claim 1, wherein the operations further comprise:
classifying, using an image model, each of the plurality of images; and
determining, from the plurality of images, at least one image being an outlier from remaining images of the plurality of images, wherein the at least one image is excluded from being converted into the plurality of secondary vectors.

5. The system of claim 1, wherein the classifying comprises obtaining a first output from the machine learning model based on a first combined vector in the plurality of combined vectors, wherein the first combined vector corresponds to a first image from the plurality of images, and wherein the machine learning model is configured to apply a first weight to a first portion of the first combined vector corresponding to the text data and a second weight to a second portion of the first combined vector corresponding to the first image based on a hyperparameter used during a training phase of the machine learning model.

6. The system of claim 1, wherein the text data is a description of an item associated with the transaction, and wherein the plurality of images comprises images of the item.

7. The system of claim 1, wherein the processing the transaction comprises denying the transaction in response to determining that the transaction is classified as a particular classification.

8. A method, comprising
receiving, by a computer system and from a device, transaction data associated with a transaction;
retrieving, from a server different from the device, multimedia data associated with the transaction based on the transaction data;
converting, using a first transformer, the transaction data into a first vector;
converting, using a second transformer, the multimedia data into a second vector;
generating a first combined vector based on the first vector and the second vector;
classifying, by the computer system, the transaction using a machine learning model based on the combined vector; and
processing, by the computer system, the transaction based on the classifying of the transaction.

9. The method of claim 8, further comprising:
obtaining a first output from the machine learning model based on the first combined vector, wherein the classifying is further based on the first output.

10. The method of claim 9, further comprising:
retrieving, from the server, second multimedia data associated with the transaction based on the transaction data;
converting, using the second transformer, the second multimedia data into a third vector;
generating a second combined vector based on the first vector and the third vector; and
obtaining a second output from the machine learning model based on the second combined vector, wherein the classifying is further based on the second output.

11. The method of claim 8, wherein the transaction is a purchase transaction from a merchant website, and wherein the method further comprises:
scanning the merchant website for product data associated with products offered for sale on the merchant website; and
generating additional data based on the scanning, wherein the classifying is further based on the additional data.

12. The method of claim 8, wherein the operations further comprise:
generating a query based on the transaction data; and
submitting the query to the server, wherein the multimedia data is retrieved from the server based on the submitting the query.

13. The method of claim 8, wherein the transaction data comprises text data, and wherein the multimedia data comprises image data.

14. The method of claim 13, wherein the first transformer is a language transformer, and wherein the second transformer is a vision transformer.

15. A non-transitory machine-readable medium having stored thereon machine-readable instructions executable to cause a machine to perform operations comprising:
receiving, from a device, a request to process a transaction between a merchant and a user, wherein the request comprises text data associated with the transaction;
generating a search query based on the text data;
retrieving, from a server different from the device, a plurality of images associated with the transaction based on the search query;
converting, using a language transformer, the text data into a first vector;
converting, using a vision transformer, the plurality of images into a plurality of secondary vectors;
generating a plurality of combined vectors based on pairing the first vector with each of the plurality of secondary vectors;
classifying the transaction using a machine learning model based on the plurality of combined vectors; and
processing the transaction based on the classifying of the transaction.

16. The non-transitory machine-readable medium of claim 15, wherein the device is associated with one of the merchant or the user.

17. The non-transitory machine-readable medium of claim 15, wherein the operations further comprise:
iteratively providing each one of the plurality of combined vectors to the machine learning model; and
obtaining a plurality of outputs from the machine learning model based on the plurality of combined vectors, wherein the classifying is further based on the plurality of outputs.

18. The non-transitory machine-readable medium of claim 17, wherein the operations further comprise:
calculating a composite output based on the plurality of outputs, wherein the classifying is further based on the composite output.

19. The non-transitory machine-readable medium of claim 15, wherein the operations further comprise:
classifying, using an image model, each of the plurality of images; and
determining, from the plurality of images, at least one image being an outlier from remaining images of the plurality of images, wherein the at least one image is excluded from being converted into the plurality of secondary vectors.

20. The non-transitory machine-readable medium of claim 15, wherein the processing the transaction comprises denying the transaction in response to determining that the transaction is classified as a particular classification.
